(19) United States
(12) Patent Application Publication
(10) Pub. No.: US 2024/0329926 A1
(43) Pub. Date: Oct. 3, 2024

(54) METHOD AND DEVICE FOR ACQUIRING COMPREHENSIVE ARRANGEMENT DATA OF MULTI-COLUMN DATA

(71) Applicant: UPC IP GROUP, Shanghai (CN)

(72) Inventor: Silin ZHENG, Shanghai (CN)

(73) Assignee: UPC IP GROUP, Shanghai (CN)

(21) Appl. No.: 18/740,637

(22) Filed: Jun. 12, 2024

Related U.S. Application Data
(63) Continuation of application No. PCT/CN2022/117762, filed on Sep. 8, 2022.

(30) Foreign Application Priority Data
Dec. 28, 2021 (CN) 202111627860.4

(51) Int. Cl. G06F 7/08

(52) U.S. Cl. CPC G06F 7/08

(57) ABSTRACT

A method and device for acquiring comprehensive arrangement data of multi-column data includes: obtaining sorting request information about one or more target column identification information in multi-column data, wherein the multi-column data comprises a plurality of row identification information corresponding to the multi-column data, and the sorting request information comprises sorting rule information corresponding to the one or more target column identification information; in response to the sorting request information, determining a row-column mapping relationship between the plurality of row identification information and the one or more target column identification information according to the sorting rule information, and determining a sorted row identification sequence according to the sorting rule information and the row-column mapping relationship; determining corresponding comprehensive arrangement data according to the row identification sequence and the row data corresponding to the plurality of row identification information.

### CROSS-REFERENCE TO RELATED APPLICATIONS

This application is the U.S. Continuing Application of International Application No. PCT/CN2022/117762 filed on 8 Sep. 2022 which designated the U.S. and claims priority to Chinese Application No. CN202111627860.4 filed on 28 Dec. 2021, the entire contents of each of which are hereby incorporated by reference.

### TECHNICAL FIELD

The invention relates to the field of communication, in particular to a technology for acquiring comprehensive arrangement data of multi-column data.

### BACKGROUND ART

When retrieving a list, it is often necessary to sort the results or even multiple columns. The existing relational database has the advantages of unified format (here mainly refers to the unified header) and easy to query, which is widely used in all walks of life. At present, the business data of most companies will be stored in the relational database. The index mechanism provided by the database has better optimization for the query and sorting of single table or original data. However, in practice, the data may be stored in multiple tables, and it is even necessary to calculate the results from multiple tables, and then sort the sequence of the results. For such a complex scenario, simply using simple SQL splicing to achieve query sorting cannot meet the actual business needs.

### SUMMARY OF THE INVENTION

An object of the present application is to provide a method and device for acquiring comprehensive arrangement data of multi-column data.

According to one aspect of the present application, a method is provided for acquiring comprehensive arrangement data of multi-column data, wherein the method comprises:
Obtaining sorting request information about one or more target column identification information in multi-column data, wherein the multi-column data comprises a plurality of row identification information corresponding to the multi-column data, and the sorting request information comprises sorting rule information corresponding to the one or more target column identification information;
In response to the sorting request information, determining a row-column mapping relationship between the plurality of row identification information and the one or more target column identification information according to the sorting rule information, and determining a sorted row identification sequence according to the sorting rule information and the row-column mapping relationship;
Determining corresponding comprehensive arrangement data according to the row identification sequence and the row data corresponding to the plurality of row identification information.

According to another aspect of the present application, a device is provided for acquiring comprehensive arrangement data of multi-column data, wherein the device comprises:
One one module, configured to obtain sorting request information about one or more target column identification information in multi-column data, wherein the multi-column data comprises a plurality of row identification information corresponding to the multi-column data, and the sorting request information comprises sorting rule information corresponding to the one or more target column identification information;
One two module, configured to in response to the sorting request information, determine a row-column mapping relationship between the plurality of row identification information and the one or more target column identification information according to the sorting rule information, and determine a sorted row identification sequence according to the sorting rule information and the row-column mapping relationship;
One three module, configured to determine corresponding comprehensive arrangement data according to the row identification sequence and the row data corresponding to the plurality of row identification information.

According to one aspect of the present application, there is provided a computer device, comprising:
one or more processors; and
a storage apparatus for storing computer executable instructions, which carry out the steps of a method as described in any of the above when the executable instruction is being executed.

According to an aspect of the present application, there is provided a computer-readable storage medium, storing one or more compute programs/instructions which implement the steps of a method as described in any of the above when executed.

According to an aspect of the present application, there is provided a computer program product, comprising computer programs/instructions which implement the steps of a method according to any of the above when executed by a processor.

Compared with the prior art, this application determines the corresponding comprehensive arrangement data by sorting and optimizing the multi-column data, realizes the convenient and quick column data sorting, improves the data processing efficiency, and brings good user experience.

### BRIEF DESCRIPTION OF THE DRAWINGS

Other features, objects, and advantages of the present application will become more apparent upon reading the detailed description of the non-limiting embodiments with reference to the following drawings:

FIG. 1 illustrates a flow chart of a method for acquiring comprehensive arrangement data of multi-column data according to an embodiment of the present application;

FIG. 2 illustrates functional modules of a computer device according to another embodiment of the present application;

FIG. 3 illustrates an exemplary system that may be used to implement various embodiments described herein.

The same or similar reference numbers in the drawings represent the same or similar parts.

### DETAILED DESCRIPTION OF THE INVENTION

The present application is described in further detail below with reference to the accompanying drawings.

In a typical configuration of the present application, the terminal, the device of the service network, and the trusted party each include one or more processors (e.g., a Central Processing Unit (CPU)), an input/output interface, a network interface, and a memory.

Memory may include volatile memory in a computer-readable medium, Random Access Memory (RAM), and/or non-volatile memory such as Read Only Memory (ROM) or Flash Memory. Memory is an example of a computer-readable medium.

Computer readable media, including both permanent and non-permanent, removable and non-removable media, may be implemented in any method or technology for information storage. Information may be computer readable instructions, data structures, modules of programs, or other data. Examples of computer storage media include, but are not limited to, Phase Change Memory (PCM), Programmable Random Access Memory (PRAM), Static Random Access Memory (SRAM), Dynamic Random Access Memory (DRAM), other types of random access memory (RAM), Read-Only Memory (ROM), Electrically Erasable Programmable Read-Only Memory (EEPROM), flash memory or other memory technologies, Compact Disc Read-Only Memory(CD-ROM), Digital Versatile Disks (DVD) or other optical storage, magnetic cassettes, Magnetic tape disk storage or other magnetic storage devices or any other non-transmission medium that can be used to store information that can be accessed by a computing device.

The device referred to herein includes, but is not limited to, a user device, a network device, or a device formed by integrating the user device and the network device through a network. The user device includes, but is not limited to, any mobile electronic product that can perform human-computer interaction with a user (for example, human-computer interaction through a touch pad), such as a smart phone, a tablet computer, etc. The mobile electronic product may adopt any operating system, such as an Android operating system, an iOS operating system, etc. The network device comprises an electronic device capable of automatically performing numerical calculation and information processing according to a preset or stored instruction, and the hardware thereof comprises but is not limited to a microprocessor and an Application Specific Integrated Circuit (ASIC), Programmable Logic Device (PLD), Field Programmable Gate Array (FPGA), Digital Signal Processor (DSP), embedded devices, etc. The network device includes, but is not limited to, a computer, a network host, a single network server, a set of multiple network servers, or a cloud of multiple servers; Here, the cloud is composed of a large number of computers or network servers based on Cloud Computing, wherein the cloud computing is a kind of distributed computing, and is a virtual supercomputer composed of a group of loosely coupled computer sets. The network includes, but is not limited to, the Internet, a wide area network, a metropolitan area network, a local area network, a VPN network, a wireless ad hoc network, and the like. Preferably, the device may also be a program running on the user device, the network device, or the user device and the network device, the touch terminal, or the device formed by integrating the network device and the touch terminal through the network.

Of course, those skilled in the art should understand that the above devices are only examples, and other existing or future devices that may be applicable to the present application should also be included in the scope of protection of the present application, and are hereby incorporated by reference.

In the description of this application, “a plurality” means two or more unless specifically defined otherwise.

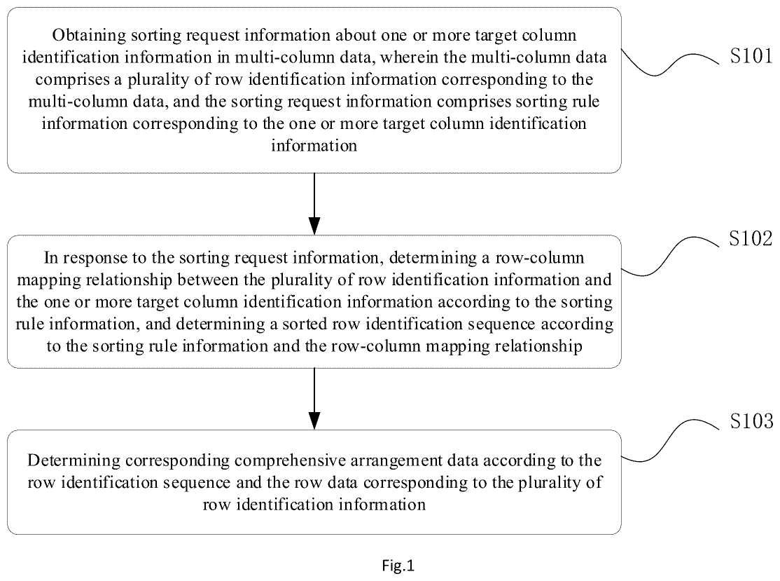

FIG. 1 illustrates a method for acquiring comprehensive arrangement data of multi-column data according to one aspect of the present application, which is applied to a computer device, wherein the method comprises step S101, step S102, and step S103. In step S101, obtaining sorting request information about one or more target column identification information in multi-column data, wherein the multi-column data comprises a plurality of row identification information corresponding to the multi-column data, and the sorting request information comprises sorting rule information corresponding to the one or more target column identification information. In step S102, in response to the sorting request information, determining a row-column mapping relationship between the plurality of row identification information and the one or more target column identification information according to the sorting rule information, and determining a sorted row identification sequence according to the sorting rule information and the row-column mapping relationship. In step S103, determining corresponding comprehensive arrangement data according to the row identification sequence and the row data corresponding to the plurality of row identification information. The computer device is a user device, a network device, or a device formed by integrating the user device and the network device through a network. The user device includes but is not limited to any mobile electronic product, such as a smart phone, a tablet computer, a personal computer, and the like, which can perform human-computer interaction with a user (for example, human-computer interaction through a touch pad). And the network device includes but is not limited to a computer, a network host, a single network server, a set of multiple network servers, or a cloud composed of multiple servers. The implementation of the solution may be completed locally in the user device (such as the user terminal), or the user device sends the data to the network device and returns the processing result (such as the comprehensive arrangement data) to the user device after the data is processed by the network device. In this application, the following embodiments are described by taking the local processing of the user device as an example. And those skilled in the art should understand that the embodiments are also applicable to the network device, the integration device of the user device and the network device, and the like.

Specifically, in the step S101, obtaining sorting request information about one or more target column identification information in multi-column data, wherein the multi-column data comprises a plurality of row identification information corresponding to the multi-column data, and the sorting request information comprises sorting rule information corresponding to the one or more target column identification information. For example, a user holds a user device (such as a personal computer). A corresponding form application (such as excel) is installed on the personal computer. And multi-column data are stored through the form application, wherein each column of the multi-column data comprises corresponding column identification information, and each row of data comprises corresponding row identification information. That is, the multi-column data comprise a corresponding initial row identification sequence. The initial row identification sequence comprises a column of row identification information for identifying each row of data in the multi-column data. And the initial row identification sequence is not included in the target column identification information for determining the sorting order. A specific example is shown in Table 1 below, wherein the corresponding column data includes two column data corresponding to “student number” and “name”. And each row of data has one corresponding row identification information, such as “10001” and “10002” contained in the column data of “student number”. And the set of the row identification information constitutes the initial row identification sequence in the multi-column data. In other words, the initial row identification sequence in the multi-column data comprise all row identification information of the multi-column data.

TABLE 1

| Student number | Name |
|---|---|
| 10001 | Student A |
| 10002 | Student B |

In some cases, the user device can obtain the sorting operation of the user on the multi-column data, and generate the corresponding sorting request information. For example, a sorting control is set in the corresponding table application. And the user can enable the sorting function by touching the sorting control. Of course, the user can set a corresponding sorting requirement when starting the sorting function, such as setting the target column identification information to be sorted and the sorting rule (for example, forward or reverse) of each target column identification information. In other cases, there is corresponding column sorting information among the corresponding target column identification information. And the column sorting information is used to indicate the column sorting order among the plurality of target column identification information. Wherein the target column identification information includes indication information for identifying the data type of the corresponding column data in the multi-column data, such as “name” described in Table 1.

Here, the multi-column data includes table data composed of a plurality of column data corresponding to a plurality of column identification information stored in the same table, wherein the number of the column data corresponding to the plurality of column identification information may be the same or different. In other words, the data in the plurality of column identification information corresponding to the initial row identification sequence may have null values. In other cases, the corresponding multi-column data may be entered directly in the same table, or may be synthesized from multi-column data in multiple tables. For example, in some embodiments, the method further comprises step S104 (not shown). In the step S104, obtaining table data corresponding to a plurality of tables, wherein each table data comprises at least two column data, which comprise column data composed of the plurality of row identification information; and generating the multi-column data according to the table data corresponding to the plurality of tables. For example, the multi-column data stored in the user device is generated from table data corresponding to a plurality of tables. Specifically, in addition to the data shown in Table 1, it may also include column data shown in Table 2. And the computer device generates corresponding multi-column data according to the combination of the column data shown in Table 1 and the column data shown in Table 2, specifically, as the multi-column data shown in Table 3. The data in Table 2 are as follows:

TABLE 2

| Student number | Score | Subject |
|---|---|---|
| 10001 | 98 | Chinese |
| 10002 | 92 | English |
| 10002 | 80 | Chinese |
| 10001 | 93 | English |

The data in Table 3 are as follows:

TABLE 3

| Student number | Name | Chinese scores | English scores |
|---|---|---|---|
| 10001 | Student A | 98 | 93 |
| 10002 | Student B | 80 | 92 |

Wherein each of the plurality of table data comprises at least two column data, and the at least two column data comprise a table row identification sequence corresponding to row identification information. The row identification information in the corresponding table row identification sequence is arranged in a sequence different from that in the corresponding initial row identification sequence. The row identification information in each table row identification sequence includes all row identification information in the initial row identification sequence, and is used to integrate the data related to the same row identification information in the multiple table data into the corresponding key (for example, the number of the row and the column in the corresponding multi-column data) when integrating the multi-column data. When the column data in the plurality of table data are integrated, the multi-column data can be directly merged, or one or more new column identification information can be generated according to the corresponding column data, and then one or more new column data are integrated and merged into the corresponding multi-column data. And the order of integration of the plurality of table data can be random or specified by a user. The integration can also be performed according to a preset order (for example, according to the sequence number of the table).

The sorting rule information comprises a data sorting sequence corresponding to the column data in the one or more pieces of target column identification information, wherein the data sorting sequence comprises a sequence or a reverse sequence. The sequence is from small to large, from front to back. And the reverse sequence is from large to small, from back to front, and the like. In some cases, when the number of the corresponding target column identification information includes a plurality. The sorting rule information further includes column sorting information for the sorting order of the plurality of target column identification information. For example, sorting the “Chinese scores” first, and then sorting the “English scores”, so as to determine the primary and secondary order of the corresponding sorting, and the like. In some embodiments, the one or more target column identification information comprise a plurality of target column identification information, and the sorting rule information comprises column sorting information of the plurality of pieces of target column identification information and data sorting information of each piece of target column identification information. For example, the column sorting information is used to indicate the primary and secondary order of sorting of each target column identification information among the plurality of target column identification information, wherein the target column identification information in the primary order is used to indicate the column data to be subjected to the data sorting information first. The target column identification information corresponding to the secondary order is used to indicate that the multi-column data sorted according to the target column identification information in the primary order are sorted again according to the target column identification information corresponding to the secondary order. And the data sorted according to the target column identification information in the secondary order includes parallel data in the multi-column data sorted according to the target column identification information in the primary order.

In step S102, in response to the sorting request information, determining a row-column mapping relationship between the plurality of row identification information and the one or more target column identification information according to the sorting rule information, and determining a sorted row identification sequence according to the sorting rule information and the row-column mapping relationship. For example, in response to the sorting request information, the computer device determines the row-column mapping relationship between the column data in the corresponding target column identification information and the row identification of each column data according to the sorting rule information, and then combines one or more row-column mapping relationship according to the sorting rule information to determine the row identification sequence of the final sorting.

In some embodiments, the data format of the row-column mapping relationship comprises a key-value pair data format. For example, the data format corresponding to the row-column mapping relationship includes, but is not limited to, a key-value pair data format, such as JSON (JavaScript Object Notation), JWT (JSON web token), map storage, and the like. Wherein the JSON data structure includes a collection of name/value pairs. It is understood in different languages as Object, Records, struct, dictionary, hash table, keyed list, or an associative array, etc. JSON data structures also include an ordered list of values, which in most languages is understood as an array. By enclose that string in double quotation mark, and by nesting arrays and objects in the array, for example,

″score″: [
{
″Zhang San″: 80,
″Li Si″: 90
}
].

In some cases, the corresponding sorting rule information may also be represented by the data format described above,

[
{
″col″: Chinese scores,
″ord″: ″desc″
}
].

Wherein the col represents the corresponding target column identification information to be sorted, ord represents the data sorting information of the column data to which the target column identification information belongs, and desc represents that the data sorting information is sorted in descending order.

The corresponding row-column mapping relationship can be expressed as,

CIR (Col And IdRelation, CIR) = [
″Column Data 1″: [Row ID 1, Row ID 3],
″Column Data 2″: [Row ID 2],
″Column Data 3″: [Row ID 4]
}
].

The column data in the target column identification information has corresponding row identification information. And one or more row identification information may be corresponding to one column data. Here, the column data corresponding to the target column identification information is used as the key information to be sorted. And the corresponding row identification information is used as the value information corresponding to the sorted key. In some cases, when the column data is the same, the orderliness of the corresponding row identification is not guaranteed, that is, randomness may occur when there are multiple data identifiers. In practical scenarios, however, it is often desirable to get consistent results from multiple requests. In order to ensure the consistency of the results, after the current target column identification information is sorted, the row identification information may be additionally sorted in a positive order/negative order, or the row identification information may be further sorted on the current basis based on other target column identification information until one column of data does not correspond to multiple row identification information.

In some embodiments, in the step S102, in response to the sorting request information, obtaining a row-column mapping relationship corresponding to each column identification information according to the data sorting information of each target column identification information in the plurality of target column identification information, so as to obtain a plurality of row-column mapping relationship; and determining the sorted row identification sequence according to the plurality of row-column mapping relationship and the column sorting information. For example, the row-column mapping relationship is used to indicate the mapping relationship between the sorted column data in the target column identification information and the corresponding row identification information, which is determined according to the predetermined sorting rule. And the row-column mapping relationship is specifically embodied as the corresponding relationship between the key serving as the column data and the value of the row identification corresponding to the key. The computer device obtains the row-column mapping relationship of each target column identification information in the plurality of target column identification information, and then determines the final row identification sequence according to the plurality of row-column mapping relationship. For example, combining according to the plurality of row-column mapping relationship, and determining the row identification sequence based on the combination result, wherein the combination order may be random, determined based on a preset rule, or specified by a user.

In some embodiments, the determining that sorted row identification sequence according to the plurality of row-column mapping relationship and the column sorting informatio, comprises: combining the row-column mapping relationship corresponding to the first column identification information and the row-column mapping relationship corresponding to the subsequent column identification information in sequence according to the column sorting information until the row-column mapping relationship corresponding to the last column identification information in the column sorting information is combined, and determining the combined row-column mapping relationship after the column identification information is combined; and determining the sorted row identification sequence according to the combined row-column mapping relationship. For example, we characterize a plurality of different target column identification information(Column) in the sequencing requirements by Col1, Col2 . . . Coln. We refer to the order requirement (orderBy, positive order or reverse order) of the column sorting information in sorting order by Ord1, Ord2 . . . Ordn. CIR1, CIR2 . . . CRn refers to the row-column mapping relationship between Col and Id. OrdR1, OrdR2 . . . OrdRn refers to the result of sorting Col1-Coln, and OrdRn is the final row identification sequence. We can calculate the final row identification sequence by the following steps:
1) obtaining the CIR group in the multi-column data, for example, taking the column data of each column in the multi-column data as the key information, and taking the corresponding row identification information as the corresponding value information so as to obtain the CIR group corresponding to each column;
2) determining the corresponding CIR1 according to the target column identification information contained in Col1, and processing the CIR1 according to Ord1 to obtain OrdR1 (the first sort is special and does not need to be combined with other sorts, but only needs to be in positive or negative order);
3) determining the corresponding CIR2 according to the target column identification information contained in Col2, and pre-sorting the CIR2 first (same as step 2, the CIR2 is sorted in positive or negative order according to Ord2). And then combining CIR1 and the pre-sorting result of CIR2 to obtain OrdR2 (combining the keys in OrdR1 with each key in CIR2 one by one, and taking the intersection of the value of the combined keys to determine the corresponding transition row identification sequence);
4) repeating the step 3 to perform combined sorting on Col3 to Coln to obtain a final transition row identification sequence.

In the above combination process, multiple target column identification information is combined in turn. If all keys/values are combined, a large amount of calculation will be generated. Here, we can perform certain optimization to improve the calculation efficiency on the basis of ensuring the calculation accuracy. Specifically, for example, when combining keys one by one, if there is only one value (that is, the array has only one element, or the length of the array is 1), it can be skipped (an element does not need to be sorted). For example, in some embodiments, the combining the row-column mapping relationship corresponding to the first column identification information and the row-column mapping relationship corresponding to the subsequent column identification information in sequence according to the column sorting information includes determining corresponding repeated row-column data from the row-column mapping relationship corresponding to the first column identification information in sequence according to the column sorting information, and combining the repeated row-column data with the row-column mapping relation corresponding to the subsequent column identification information.

For another example, each key is combined, the intersection of its values is taken, and finally the array whose combined value is null is filtered. That is, the corresponding combined value is removed as a null value. Furthermore, when a null value is encountered in the combination process, the null value can be directly ignored, and the performance loss caused by the final filtering of the null value is omitted. In some embodiments, the determining the sorted row identification sequence according to the combined row-column mapping relationship includes removing null values in the combined row-column mapping relationship to obtain the sorted row identification sequence.

In step S103, determining corresponding comprehensive arrangement data according to the row identification sequence and the row data corresponding to the plurality of row identification information. For example, according to the row identification sequence determined by the final sorting, the computer device fills the data of each row according to the column identification information of each column according to the sorting of the row identification information in the row identification sequence, so as to generate the final comprehensive arrangement data.

For example, for multi-column data containing column identification information corresponding to “obligee” and “undertaker”, the corresponding initial row identification information is the sequence number of each row of data, such as 1, 2, 3 . . . 7 etc.

### 1) Analytic Parameter

[{“col”: “obligee column”, “ord”: “desc” }, {“col”: “undertaker column”, “ord”: “asc” }]

The corresponding sorting rule information includes: first, the obligee is listed in descending order, and then the case ID associated with the same obligee is listed in ascending order according to the undertaker.

Col1=obligee column
Ord1=desc (descending, largest to smallest)
Col2=undertaker column
Ord2=asc(ascending, smallest to largest)

### 2) Get the Column and ID Relationship

```
# Get raw data (raw data in ascending order by default)
# raw data of obligee CIR (ascending order)
CIR1 = {
  1) ″ Obligee 1″: [1,2,5],
  2) ″Obligee 2″: [3, 7],
  3) ″Obligee 3″: [4,6]
}
# raw data of undertaker CIR (ascending order)
CIR2 = {
  4) ″Undertaker 1 ″: [1,5,6],
  5) ″Undertaker 2″: [3,4,7],
  6) ″Undertaker 3″: [2]
}
```

### 3) Combination Sorting

Firstly, OrdR1 is obtained according to Ord1 and CIR1, Ord1 is in descending order, and CIR1 is reversed

OrdR1 = {
1) ″Obligee 3 ″: [4,6],
″ Obligee 2″: [3, 7],
″Obligee 1″: [1,2,5]
}

OrdR2 is obtained according to Ord2, OrdR1 and CIR2, and Ord1 is in ascending order, so CIR2 does not need to be preprocessed, and CIR2 and OrdR1 can be combined and sorted directly

```
# # Raw Data
CIR2 = {
  1) ″Undertaker 1″: [1,5,6],
  2) ″Undertaker 2″: [3,4,7],
  3) ″Undertaker 3″: [2]
}
OrdR1 = {
  4) ″Obligee 3″: [4,6],
″Obligee 2″: [3, 7],
″ Obligee 1″: [1,2,5]
}
```

## The keys in OrdR1 and CIR2 are combined one by one, and the intersection of the values is taken to obtain the following result

```
{
  ″ Obligee 3-Undertaker 1″: [6],
  ″ Obligee 3-Undertaker 2″: [4],
  ″ Obligee 3-Undertaker 3 ″: [ ],
  ″ Obligee 2-Undertaker 1 ″: [ ],
  ″ Obligee 2-Undertaker 2 ″: [3,7],
  ″ Obligee 2-Undertaker 3 ″: [ ],
  ″ Obligee 1-Undertaker 1 ″: [1,5],
  ″ Obligee 1-Undertaker 2 ″: [ ],
  ″ Obligee 1-Undertaker 3 ″: [2]
}
```

## Remove the key whose value is an empty array to get OrdR2

```
OrdR2 = {
  ″ Obligee 3-Undertaker 1 ″: [6],
  ″ Obligee 3-Undertaker 2 ″: [4],
  ″ Obligee 2-Undertaker 2 ″: [3,7],
  ″ Obligee 1-Undertaker 1 ″: [1,5],
  ″ Obligee 1-Undertaker 3 ″: [2]
}
```

Wherein, the corresponding final row identification sequence is: 6, 4, 3/7, 1/5, 2. In some cases, we can arrange the parallel data in sequence order to ensure the consistency of the sorting results, so that the row identification sequence is expressed as: 6, 4, 3, 7, 1, 5, 2.

In some embodiments, the method further comprises step S105 (not shown). In step S105, obtaining a paging request about the comprehensive arrangement data, wherein the paging request comprises corresponding paging interval information; and in response to the paging request, performing paging processing on the comprehensive arrangement data according to the paging interval information to obtain corresponding multi-page arrangement data. For example, after the computer device determines the comprehensive arrangement data according to the sorting rule information, the computer device may further perform related operations on the comprehensive arrangement data to obtain the data desired by the user. For example, the computer device may determine a paging request for the comprehensive arrangement data based on a user operation. The paging request includes corresponding paging interval information, wherein the paging interval information includes the number of rows of row data included in each page after the corresponding paging. Here, the paging request may be obtained after the comprehensive arrangement data is discharged, or may be obtained together during the sorting, so that the computer device may directly perform the corresponding paging operation during the sorting process, and determine the multi-page arrangement data after the paging. The computer device performs paging processing on the comprehensive arrangement data according to the paging interval information (for example, one page by three), and determines the corresponding multi-page arrangement data according to the format of three rows of data per page.

In some embodiments, the method further comprises step S106 (not shown). In step S106, acquiring a value request of the multi-page arrangement data, wherein the value request comprises the page number of corresponding value page; and responding to the value request, determining the page data corresponding to the value page from the multi-page arrangement data. For example, on the basis of the paging operation, the user can also perform a value operation on the data of a specific page in the multi-page arrangement data, so as to separately obtain the data of a certain page in the multi-page arrangement data. For example, according to the requirement of “three second pages per page”, the element may fall in “Obligee 2” or “Obligee 1”. In this case, “Obligee 3” can be ignored, and OrdR1 can be simplified as follows:

OrdR1 = {
″ Obligee 2 ″: [3, 7],
″ Obligee 1 ″: [1,2,5]
}

Among them, there are three elements in “Obligee 1”. Since the order of these three elements cannot be determined, one of them cannot be partially ignored until it is divided by subsequent sorting.

In some embodiments, the target column identification information includes, but is not limited to, undertaker information; obligee information; the time information of case registration; the time information of case trial. For example, the multi-column sorting information is used to determine a case statistical system. The case statistical system includes multi-column data. And the column identification information corresponding to the multi-column data includes but is not limited to undertaker information, obligee information, the time information of case registration, the time information of case tria, etc., wherein the undertaker information is used to indicate the case handling personnel, the obligee information is used to indicate the holder of the claim right of the case, the time information of case registration indicates the time of acceptance of the case, and the time information of case trial indicates the trial time of the first or second instance of the case.

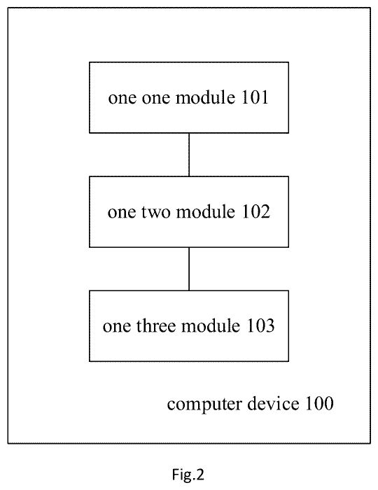

In the above, each embodiment of acquiring comprehensive arrangement data of multi-column data in the present application is mainly described in detail. In addition, the present application also provides a device capable of implementing the above embodiment, which is described below with reference to FIG. 2.

FIG. 2 illustrates a computer device for acquiring comprehensive arrangement data of multi-column data according to an aspect of the present application, wherein the device includes a one one module 101, a one two module 102, and a one three module 103. The one one module 101 is configured to obtain sorting request information about one or more target column identification information in multi-column data, wherein the multi-column data comprises a plurality of row identification information corresponding to the multi-column data, and the sorting request information comprises sorting rule information corresponding to the one or more target column identification information. The one two module 102 is configured to in response to the sorting request information, determine a row-column mapping relationship between the plurality of row identification information and the one or more target column identification information according to the sorting rule information, and determine a sorted row identification sequence according to the sorting rule information and the row-column mapping relationship. The one three module 103 is configured to determine corresponding comprehensive arrangement data according to the row identification sequence and the row data corresponding to the plurality of row identification information.

Here, the corresponding embodiments of the one one module 101, the one two module 102, and the one three module 103 shown in FIG. 2 are the same as or similar to the embodiments of the step S101, the step S102, and the step S103 shown in FIG. 1, and thus are not repeated here.

In some embodiments, the device further comprises one four modules (not shown) for obtaining table data corresponding to a plurality of tables, wherein each table data comprises at least two column data, which comprise column data composed of the plurality of row identification information; and generating the multi-column data according to the table data corresponding to the plurality of tables.

In some embodiments, the one or more pieces of target column identification information comprise a plurality of pieces of target column identification information, and the sorting rule information comprises column sorting information of the plurality of pieces of target column identification information and data sorting information of each piece of target column identification information.

In some embodiments, the data format of the row-column mapping relationship comprises a key-value pair data format.

In some embodiments, the one two module 102 is configured to, in response to the sorting request information, obtain a row-column mapping relationship corresponding to each column identification information according to the data sorting information of each target column identification information in the plurality of target column identification information, so as to obtain a plurality of row-column mapping relationship; and determine that sorted row identification sequence according to the plurality of row-column mapping relationship and the column sorting information.

In some embodiments, the determining that sorted row identification sequence according to the plurality of row-column mapping relationship and the column sorting information, comprises: combining the row-column mapping relationship corresponding to the first column identification information and the row-column mapping relationship corresponding to the subsequent column identification information in sequence according to the column sorting information until the row-column mapping relationship corresponding to the last column identification information in the column sorting information is combined, and determining the combined row-column mapping relationship after the column identification information is combined; and determining that sorted row identification sequence according to the combined row-column mapping relationship.

In some embodiments, the combining the row-column mapping relationship corresponding to the first column identification information and the row-column mapping relationship corresponding to the subsequent column identification information in sequence according to the column sorting information, comprises: determining corresponding repeated row-column data from the row-column mapping relationship corresponding to the first column identification information in sequence according to the column sorting information, and combining the repeated row-column data with the row-column mapping relation corresponding to the subsequent column identification information.

In some embodiments, the determining that sorted row identification sequence according to the combined row-column mapping relationship, comprises: removing null values in the combined row-column mapping relationship to obtain the sorted row identification sequence.

In some embodiments, the device further comprises a one five module (not shown), for obtaining a paging request about the comprehensive arrangement data, wherein the paging request comprises corresponding paging interval information; and in response to the paging request, performing paging processing on the comprehensive arrangement data according to the paging interval information to obtain corresponding multi-page arrangement data.

In some embodiments, the device further comprises a one six module (not shown) for acquiring a value request of the multi-page arrangement data, wherein the value request comprises the page number of corresponding value page; and responding to the value request, determining the page data corresponding to the value page from the multi-page arrangement data.

In some embodiments, the target column identification information includes, but is not limited to: undertaker information; obligee information; the time information of case registration; the time information of case trial.

Here, the specific embodiments corresponding to the one four module to the one six module are the same as or similar to the embodiments of the above step S104 to S106, and thus are not repeated here.

In addition to the method and apparatus described in the above embodiments, the present application provides a computer-readable storage medium storing computer code that, when executed, performs the method as described in the preceding item.

The present application also provides a computer program product for performing the method as described in the preceding paragraph when executed by a computer equipment.

The present application also provides a computer device, the computer device comprising:
one or more processors;
a memory for storing one or more computer programs;
the one or more computer programs, when executed by the one or more processors, cause the one or more processors to perform a method as described in the preceding paragraph.

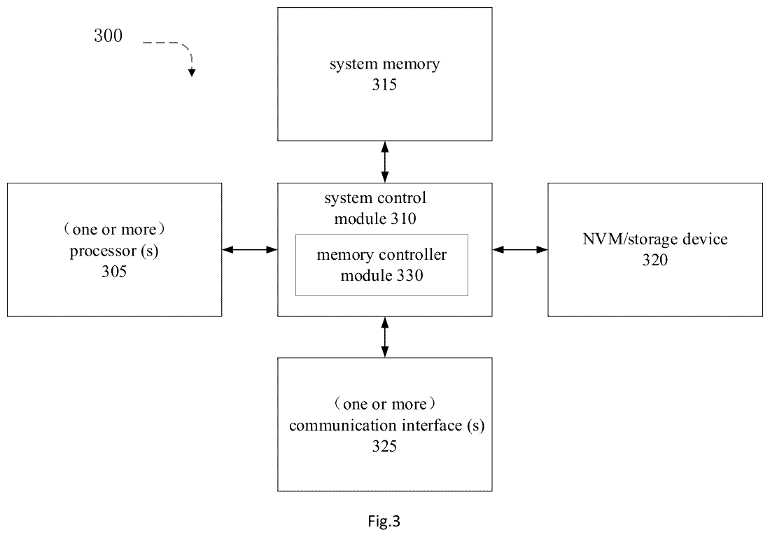

FIG. 3 illustrates an exemplary system that may be used to implement various embodiments described herein.

As shown in FIG. 3, in some embodiments, the system 300 can be implemented as any of the devices described above in the various described embodiments. In some embodiments, system 300 can include one or more computer-readable media(e.g., system memory or NVM/storage 320) having instructions and one or more processors (e.g., processor (s) 305).

For one embodiment, system control module 310 may include any suitable interface controller to provide any suitable interface to at least one of processor (s) 305 and/or any suitable device or component in communication with system control module 310.

System control module 310 may include a memory controller module 330 to provide an interface to system memory 315. The memory controller module 330 may be a hardware module, a software module, and/or a firmware module.

System memory 315 may be used, for example, to load and store data and/or instructions for system 300. For one embodiment, system memory 315 may include any suitable volatile memory, such as suitable DRAM. In some embodiments, system memory 315 may include double data rate type four synchronous dynamic random access memory (DDR4 SDRAM).

For one embodiment, system control module 310 may include one or more input/output (I/O) controllers to provide an interface to NVM/storage device 320 and communication interface (s) 325.

For example, NVM/storage device 320 may be used to store data and/or instructions. NVM/storage 320 can include any suitable non-volatile memory (e.g., flash memory) and/or can include any suitable non-volatile storage device (s) (e.g., one or more hard disk drive(s) (HDD(s)), one or more compact disc (CD) drive(s), and/or one or more digital versatile disc (DVD) drive(s)).

NVM/storage device 320 may comprise a storage resource that is physically part of the device on which system 300 is installed, or that is accessible by the device without being part of the device. For example, NVM/storage device 320 may be accessed over a network via communication interface (s) 325.

Communication interface(s) 325 may provide an interface for system 300 to communicate over one or more networks and/or with any other suitable device. System 300 can communicate wirelessly with one or more components of a wireless network in accordance with any of one or more wireless networking standards and/or protocols.

For one embodiment, at least one of the processor (s) 305 may be packaged with logic of one or more controllers (e.g., memory controller module 330) of system control module 310. For one embodiment, at least one of the processor (s) 305 may be packaged together with logic of one or more controllers of the system control module 310 to form a system-in-package (SiP). For one embodiment, at least one of the processor (s) 305 may be integrated with the logic of one or more controller(s) of the system control module 310 on the same mold. For one embodiment, at least one of the processor (s) 305 may be integrated on the same die with logic for one or more controller(s) of the system control module 310 to form a system on a chip (SoC).

In various embodiments, system 300 may be, but is not limited to being: a server, a workstation, a desktop computing device, or a mobile computing device (e.g., a laptop computing device, a handheld computing device, a tablet computer, a netbook, etc.). In various embodiments, the system 300 may have more or fewer components and/or a different architecture. For example, in some embodiments, system 300 includes one or more cameras, keyboards, liquid crystal display (LCD) screens (including touch screen displays), non-volatile memory ports, multiple antennas, graphics chips, application specific integrated circuits (ASICs), and speakers.

It is noted that the present application may be implemented in software and/or a combination of software and hardware, for example, using an application specific integrated circuit (ASIC), a general purpose computer, or any other similar hardware device. In one embodiment, the software program of the present application may be executed by a processor to perform the steps or functions described above. Likewise, the software routines(including associated data structures) of the present application may be stored on a computer readable recording medium such as RAM memory, magnetic or optical drive or diskette and the like. In addition, some of the steps or functions of the present disclosure may be implemented using hardware, for example, as circuitry that cooperates with a processor to perform the steps or functions.

In addition, a portion of the present application can be applied as a computer program product, such as computer program instructions, which, when executed by a computer, can invoke or provide methods and/or technical solutions according to the present application through the operation of the computer. It should be understood by those skilled in the art that the form of the computer program instructions in the computer readable medium includes but not limited to source files, executable files, installation package files, etc. Accordingly, the manner in which the computer program instructions are executed by the computer includes but not limited to: the computer directly executes the instructions, or the computer compiles the instructions and executes the corresponding compiled program, or the computer reads and executes the instruction, or the computer reads and installs the instruction and then executes the corresponding installed program. In this context, computer-readable media may be any available computer-readable storage media or communication media that can be accessed by a computer.

Communication media includes media in which communication signals, such as computer readable instructions, data structures, program modules, or other data are transferred from one system to another. Communication media can include conductive transmission media such as cables and wires (e.g., fiber optics, coaxial, etc.) and wireless (non-conductive transmission) media capable of propagating energy waves, such as acoustic, electromagnetic, RF, microwave, and infrared. Computer readable instructions, data structures, program modules or other data may be embodied, for example, in a modulated data signal in a wireless medium such as a carrier wave or similar mechanism embodied as part of spread spectrum technology. The term “modulated data signal” means a signal that has one or more of its characteristics changed or set in such a manner as to encode information in the signal. The modulation may be analog, digital, or mixed modulation techniques.

By way of example, and not limitation, computer-readable storage media may include volatile and non-volatile, removable and non-removable media implemented in any method or technology for storage of information such as computer-readable instructions, data structures, program modules, or other data. For example, computer-readable storage media include, but are not limited to, volatile memory such as random access memory (RAM, DRAM, SRAM), and non-volatile memory such as flash memory, various read-only memories (ROM, PROM, EPROM, EEPROM), magnetic and ferromagnetic/ferroelectric memories (MRAM, FeRAM); and magnetic and optical storage devices (hard disks, magnetic tape, CDs, DVDs), or other now known or later developed media capable of storing computer readable information/data for use with a computer system.

Here, an embodiment according to the present application includes an apparatus, the apparatus including a memory for storing computer program instructions and a processor for executing the program instructions, wherein, when the computer program instructions are executed by the processor, the apparatus is triggered to operate the method and/or technical solution based on the foregoing embodiments according to the present application.

It will be apparent to those skilled in the art that the present application is not limited to the details of the above-described exemplary embodiments, and that the present application can be embodied in other specific forms without departing from the spirit or essential characteristics thereof. The embodiments are therefore to be considered in all respects as illustrative and not restrictive, the scope of the application being defined by the appended claims rather than by the foregoing description, and all changes which come within the meaning and range of equivalency of the claims are therefore intended to be embraced therein. Any reference signs in the claims shall not be construed as limiting the claim to which they relate. Furthermore, it is clear that the word “comprising” does not exclude other elements or steps and that the singular does not exclude the plural. The units or means recited in the device claims may also be implemented by one unit or means by software or hardware. The terms first, second, etc., are used to denote names and do not denote any particular order.

What is claimed is:

1. A method for acquiring comprehensive arrangement data of multi-column data, comprising the following steps of:
obtaining sorting request information about one or more target column identification information in multi-column data, wherein the multi-column data comprises a plurality of row identification information corresponding to the multi-column data, and the sorting request information comprises sorting rule information corresponding to the one or more target column identification information;
in response to the sorting request information, determining a row-column mapping relationship between the plurality of row identification information and the one or more target column identification information according to the sorting rule information, and determining a sorted row identification sequence according to the sorting rule information and the row-column mapping relationship; and
determining corresponding comprehensive arrangement data according to the row identification sequence and the row data corresponding to the plurality of row identification information.

2. The method according to claim 1, wherein the data format of the row-column mapping relationship comprises a key-value pair data format.

3. The method according to claim 1, wherein the method further comprises:
obtaining table data corresponding to a plurality of tables, wherein each table data comprises at least two column data, which comprise column data composed of the plurality of row identification information; and
generating the multi-column data according to the table data corresponding to the plurality of tables.

4. The method according to claim 1, wherein the one or more pieces of target column identification information comprise a plurality of pieces of target column identification information, and the sorting rule information comprises column sorting information of the plurality of pieces of target column identification information and data sorting information of each piece of target column identification information.

5. The method according to claim 4, wherein the in response to the sorting request information, determining a row-column mapping relationship between the plurality of row identification information and the one or more target column identification information according to the sorting rule information, and determining a sorted row identification sequence according to the sorting rule information and the row-column mapping relationship, comprises:
in response to the sorting request information, obtaining a row-column mapping relationship corresponding to each column identification information according to the data sorting information of each target column identification information in the plurality of target column identification information, so as to obtain a plurality of row-column mapping relationship; and
determining that sorted row identification sequence according to the plurality of row-column mapping relationship and the column sorting information.

6. The method according to claim 5, wherein the determining that sorted row identification sequence according to the plurality of row-column mapping relationship and the column sorting information, comprises:
combining the row-column mapping relationship corresponding to the first column identification information and the row-column mapping relationship corresponding to the subsequent column identification information in sequence according to the column sorting information until the row-column mapping relationship corresponding to the last column identification information in the column sorting information is combined, and determining the combined row-column mapping relationship after the column identification information is combined; and
determining that sorted row identification sequence according to the combined row-column mapping relationship.

7. The method according to claim 6, wherein the combining the row-column mapping relationship corresponding to the first column identification information and the row-column mapping relationship corresponding to the subsequent column identification information in sequence according to the column sorting information, comprises:
determining corresponding repeated row-column data from the row-column mapping relationship corresponding to the first column identification information in sequence according to the column sorting information, and combining the repeated row-column data with the row-column mapping relation corresponding to the subsequent column identification information.

8. The method according to claim 6, wherein the determining the sorted row identification sequence according to the combined row-column mapping relationship, comprises:
removing null values in the combined row-column mapping relationship to obtain the sorted row identification sequence.

9. The method according to claim 1, wherein the method further comprises:
obtaining a paging request about the comprehensive arrangement data, wherein the paging request comprises corresponding paging interval information; and
in response to the paging request, performing paging processing on the comprehensive arrangement data according to the paging interval information to obtain corresponding multi-page arrangement data.

10. The method according to claim 9, wherein the method further comprises:
acquiring a value request of the multi-page arrangement data, wherein the value request comprises the page number of corresponding value page; and
responding to the value request, determining the page data corresponding to the value page from the multi-page arrangement data.

11. The method according to claim 1, wherein the target column identification information comprises at least one of the following:
undertaker information;
obligee information;
the time information of case registration;
the time information of case trial.

12. A computer device, comprises:
one or more processors; and
a storage apparatus for storing computer executable instructions, which carry out the steps of the method as claimed in claim 1 when the executable instruction is being executed.

13. A computer-readable storage medium, stores one or more compute programs/instructions, which perform the step of the method of claim 1 when executed.
